(19) United States
(12) Patent Application Publication
(10) Pub. No.: US 2011/0070389 A1
(43) Pub. Date: Mar. 24, 2011

(54) MULTI-LAYER WOVEN HEAT-SHRINKABLE COATING

(75) Inventors: Eric Jude Aulicino, Rockwell, TX (US); Stefan Krieken, Playas de Tijuana (MX)

(73) Assignee: BERRY PLASTICS CORPORATION, Evansville, IN (US)

(21) Appl. No.: 12/564,714

(22) Filed: Sep. 22, 2009

(51) Int. Cl. B32B 33/00; D03D 25/00; B05D 3/12

(52) U.S. Cl. 428/40.1; 442/149; 427/171

(57) ABSTRACT

A multi-layer coating includes an adhesive layer and a polyolefin layer. A multi-layer coating may include at least one adhesive layer and a heat shrinkable polyolefin layer.

### BACKGROUND

The present disclosure relates to a heat-shrinkable coating, in particular, a heat-shrinkable coating with an adhesive. More particularly, the present disclosure relates to a heat-shrinkable coating with an adhesive for covering a metal pipe joint.

Pipes are sold and transported in lengths which may be much shorter than their useful lengths. For example, a given application may require several miles of pipe to be laid, but manufacturing and transporting a pipe with a length of several miles is not practical. Therefore, pipes may be produced in significantly shorter lengths, such as 20, 40 or 80 foot long sections and then assembled together in the field. Metals and/or alloys, such as steel, are routinely used in the manufacture of pipes. During installation, the pipe sections can be welded together at their ends, for example, by butt-welding, to form a single pipe with an extended length.

During the manufacture of pipes, protective coatings may be installed on the surface of the pipe to protect the pipe's metal from oxidation, abrasion, and degradation. Coatings differ vastly based on the application. For example, multilayer polyethylene or polypropylene, fusion bonded epoxy (FBE), enamel, and/or rubber coatings may be used to protect a pipe depending on the environmental conditions to which the pipes will be exposed. During manufacturing, the end portions of a pipe section are left uncoated so that the pipe section can be welded together during installation without interference from or damage to the protective coating. After the pipes are welded, the unprotected end sections and the welded joint may be protected using a sleeve or coating. In combination with the protective coating installed during manufacture, the sleeve allows the protective coating to be continuous over the length of pipe.

### SUMMARY

A coating in accordance with the present disclosure includes a polyolefin layer and an adhesive layer. In illustrative embodiments, the coating is configured as a sleeve. In another embodiment, the coating is configured as a sheet which can be further configured as a wraparound sleeve during installation.

In illustrative embodiments, the polyolefin layer is heat-shrinkable and woven. In one embodiment, the polyolefin layer includes a polyolefin such as polyethylene, polypropylene, or blends thereof. In one embodiment, the polyolefin is cross-linked. For example, the polyolefin may be irradiatively cross-linked or non-irradiatively cross-linked. In one embodiment the polyolefin is cross-linked by electron-beam irradiation.

In illustrative embodiments, the adhesive layer includes one or more adhesives. For example, adhesives within the scope of the present disclosures include but are not limited to mastics, hot-melts, polyurethanes, polyimides, synthetic rubbers, and epoxies, or blend and combinations thereof. In one embodiment, the pipe coating includes a second adhesive layer. In another embodiment, the second adhesive layer comprises an adhesive distinct from the first adhesive.

In illustrative embodiments, disclosed is an apparatus for covering a pipe including one or more adhesives layers in contact with a heat-shrinkable polyolefin backing, wherein the adhesive layer and the polyolefin backing are arranged to form a composite with a non-continuous dielectric resistance. In one embodiment, the heat-shrinkable polyolefin backing is cross-linked. In another embodiment, the pipe is in contact with the adhesive upon shrinking of the heat shrinkable polyolefin backing and the contact substantially seals the pipe from water and water vapors without sealing the pipe from the passage of current.

An illustrative method of producing a heat shrinkable coating in accordance with the present disclosure comprises the steps of subjecting a woven polyolefin layer to an irradiative cross-linking process, expanding the layer utilizing a stretching device to produce an expanded woven polyolefin layer, and contacting an adhesive layer to the expanded woven polyolefin layer. In one embodiment, the method further comprises the step of contacting the adhesive layer with a release liner. In another embodiment, the method further comprises the step of rolling the film. In yet another embodiment, the method further comprises the step of preheating the woven polyolefin layer. In one embodiment, the method further comprises the step of annealing the expanded woven polyolefin layer. In another embodiment, the method further comprises the step of forming the heat shrinkable coating into a sleeve.

Additional features of the present disclosure will become apparent to those skilled in the art upon consideration of illustrative embodiments exemplifying the best mode of carrying out the disclosure as presently perceived.

### BRIEF DESCRIPTION OF THE DRAWINGS

The detailed description particularly refers to the accompanying figures in which:

FIG. 1 is a perspective view of a sleeve in accordance with the present disclosure suggesting that the sleeve is made of a heat-shrink woven material and is placed onto one end of a first metal pipe prior to joining the first metal pipe to a second metal pipe by a butt-welded joint as suggested in FIGS. 2 and 3;

FIG. 2 is a perspective view of the sleeve of FIG. 1 showing that the sleeve has been placed on the first metal pipe and moved away from the butt-weld joint area to minimize the transfer of heat from the welding of the butt-welded joint as suggested in FIG. 3;

FIG. 3 is a perspective view similar to FIG. 2 showing that the sleeve is arranged to lie in spaced-apart relation to the area where the first metal pipe and second metal pipe are welded together and suggesting that the sleeve is then slid to right to cover the finished butt-weld joint as suggested in FIG. 4;

FIG. 4 is a partial perspective view of a pipeline showing that a butt-weld joint has been established between the first metal pipe and the second metal pipe and showing that the sleeve has moved to a joint-cover position so that when heat is applied to the sleeve as suggested in FIG. 5, the heat-shrink woven material of the sleeve shrinks and conforms to the first metal pipe, the second metal pipe, and the butt-weld joint interconnecting the two pipes as suggested in FIG. 6;

FIG. 5 is a partial perspective view similar to FIGS. 3 and 4 showing the use of a torch to apply heat to all exposed exterior surfaces of the sleeve to cause the heat-shrink woven material of the sleeve to shrink;

FIG. 6 is a partial perspective view similar to FIG. 5 after heat has been applied to the heat-shrink woven material of the sleeve to form an enclosed butt-weld joint interconnecting the first metal pipe and the second metal pipe;

FIG. 7 is a partial perspective view of the enclosed butt-weld joint of FIG. 6 showing the pipeline coupled to an illustrative cathodic protection system used to prevent corrosion of the pipeline and showing that when the cathodic protection system is in use, electric current moves from the anode of the cathodic protection system to the pipeline by passing through the heat-shrink woven material of the sleeve as suggested in FIG. 8;

FIG. 8 is an enlarged partial perspective view taken about line 8-8 of FIG. 7 showing that electric current from the anode of the cathodic protection system is able to pass through gaps formed between strands of the shrink-wrap woven material so that the cathodic protection system operates properly;

FIG. 9 is an enlarged sectional view taken about line 9-9 of FIG. 6 showing the butt-welded first and second metal pipes and an exterior pipe-coating layer made of a plastic material on each of the first and second metal pipes and showing that the sleeve is positioned to cover a portion of the exterior pipe-coating layer of each pipe while covering the finished butt-weld joint interconnecting the first and second metal pipes;

FIGS. 10-13 show various embodiments of a shrink-wrap woven material in accordance with the present disclosure;

FIG. 10 is diagrammatic view of a first embodiment of a shrink-wrap woven material showing that the shrink-wrap woven material includes from top to bottom a woven polyolefin layer and an adhesive layer;

FIG. 11 is a diagrammatic view of another embodiment of a shrink-wrap woven material showing that material includes from top to bottom a first adhesive layer, a woven polyolefin layer, and a second adhesive layer;

FIG. 12 is a diagrammatic view of yet another embodiment of a shrink-wrap woven material showing that the material includes from top to bottom a woven polyolefin layer, an adhesive layer, and a release layer; and

FIG. 13 is a diagrammatic view of another embodiment of a shrink-wrap woven material showing that the material includes from top to bottom a first release layer, a first adhesive layer, a woven polyolefin layer, a second adhesive layer, and a second release layer.

### DETAILED DESCRIPTION

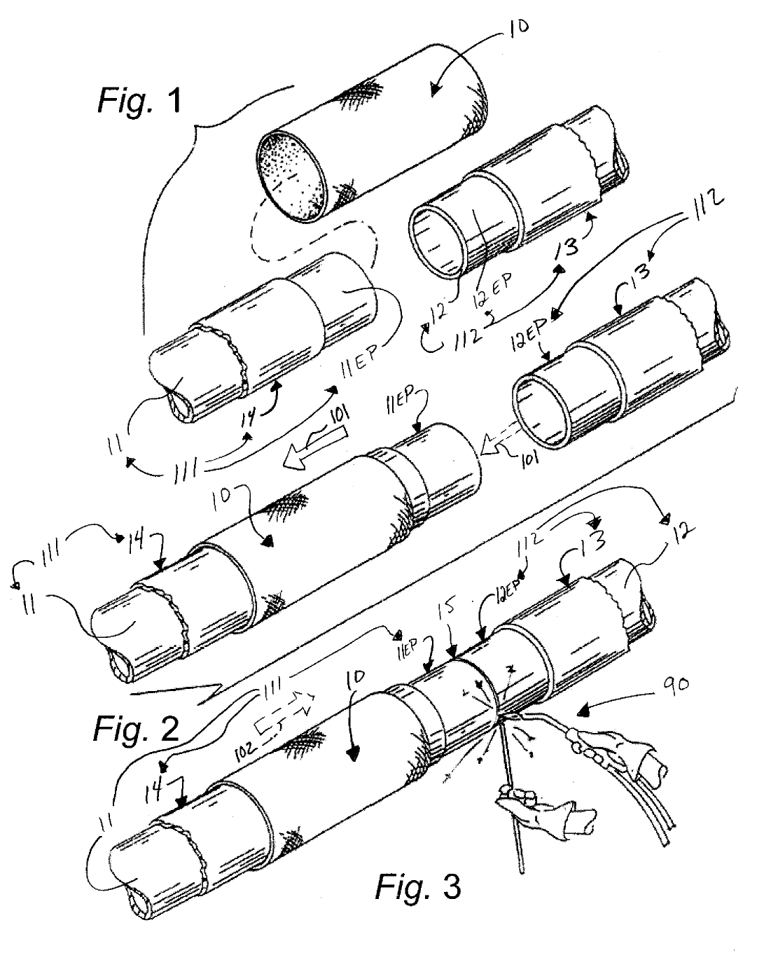

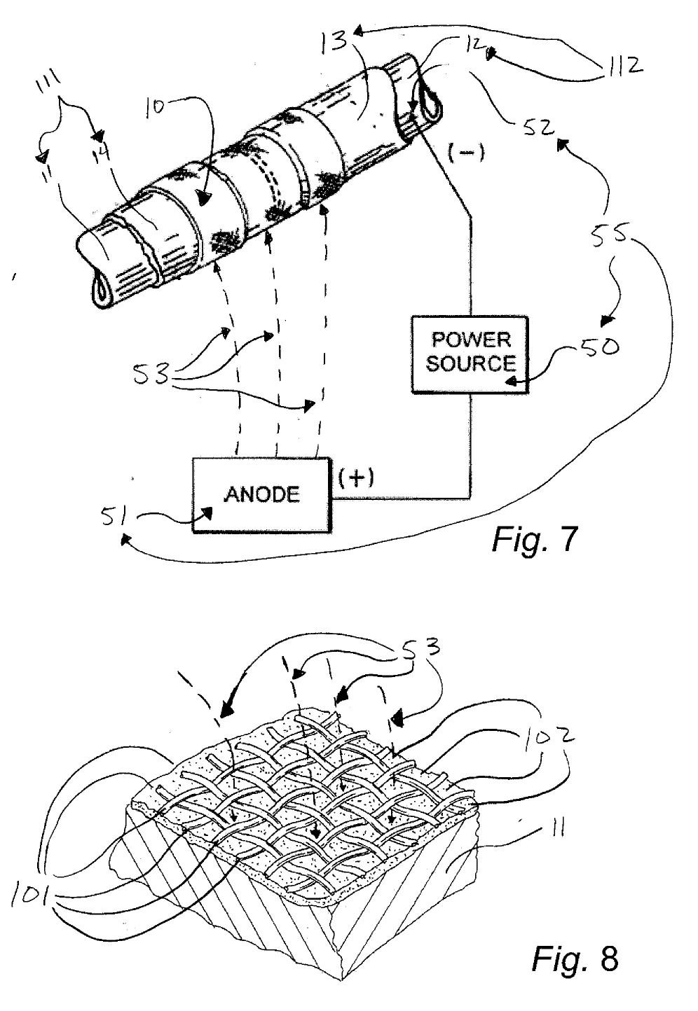

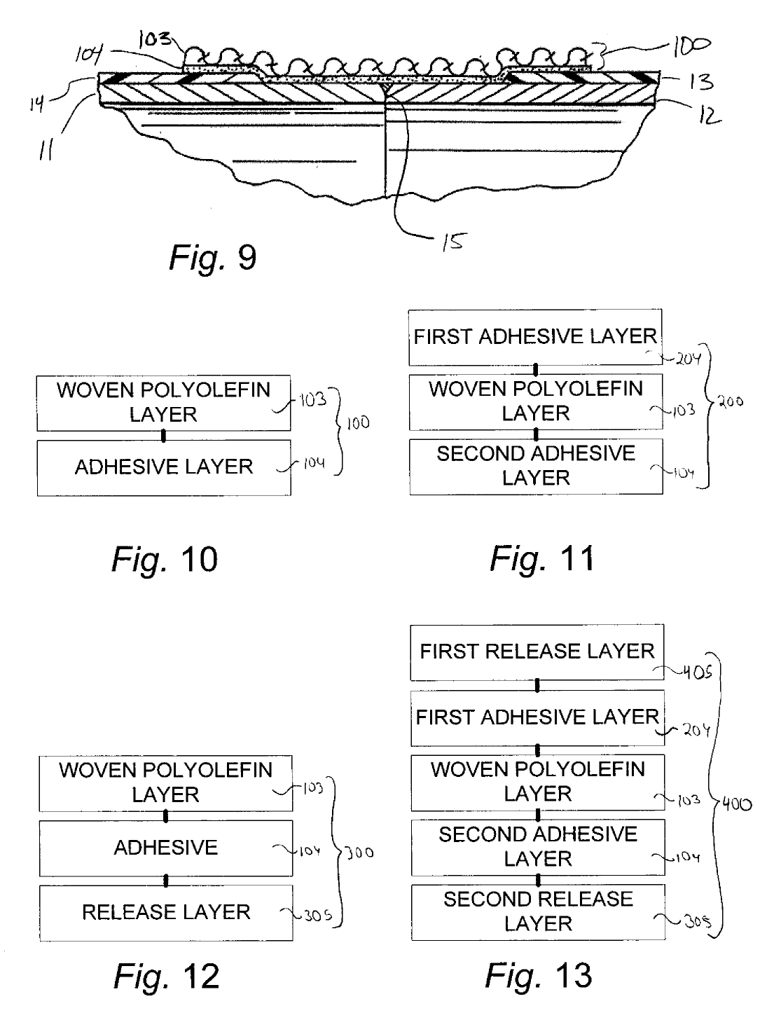

As shown in FIG. 1, a sleeve 10 in accordance with the present disclosure is formed from a coating 100 that comprises a woven polyolefin layer 103 and an adhesive layer 104 coupled to the polyolefin layer 103. Sleeve 10 is used to protect an area 16 where two metal pipes 11, 12 are joined together as suggested in FIGS. 1-6. Woven polyolefin layer 103 of sleeve 10 has heat-shrinking properties that allow sleeve 10 to shrink and conform to the shape of the underlying structure when heat is applied as shown in FIGS. 5 and 6. Woven polyolefin layer 103 is formed to include voids 102 formed between fibers 101 woven together to form woven polyolefin layer 103 as shown in FIG. 8. As suggested in FIGS. 7 and 8, woven polyolefin layer 103 allows electrons 53 to pass through voids 102 to cause a cathodic protection system 55 to function so that the pipes 11, 12 are protected from corrosion.

Several illustrative pipe-joint coatings are disclosed herein as suggested in FIGS. 10-13. A first coating 100 comprising layers 103, 104 is shown diagrammatically in FIG. 10. A second coating 200 comprising layers 204, 103, 104 is shown diagrammatically in FIG. 11. A third coating 300 comprising layers 103, 104 and 305 is shown diagrammatically in FIG. 12. A fourth coating comprising layers 405, 204, 103, and 305 is shown diagrammatically in FIG. 13.

A sleeve 10 in accordance with the present disclosure covers portions of a first pipe unit 111 and a second pipe unit 112. First pipe unit 111 includes a first steel pipe 11 and a first exterior pipe coating 14 as suggested, for example, in FIGS. 1-7. Second pipe unit 112 includes a second metal pipe 12 and a second exterior pipe coating 13. At the ends of first pipe unit 111, first metal pipe 11 extends beyond first exterior pipe coating 14 leaving a first exposed portion 11EP, for example, see FIG. 2. Similarly, second pipe unit 112 extends beyond second exterior pipe coating 13 leaving a second exposed portion 12EP, for example, see FIG. 2.

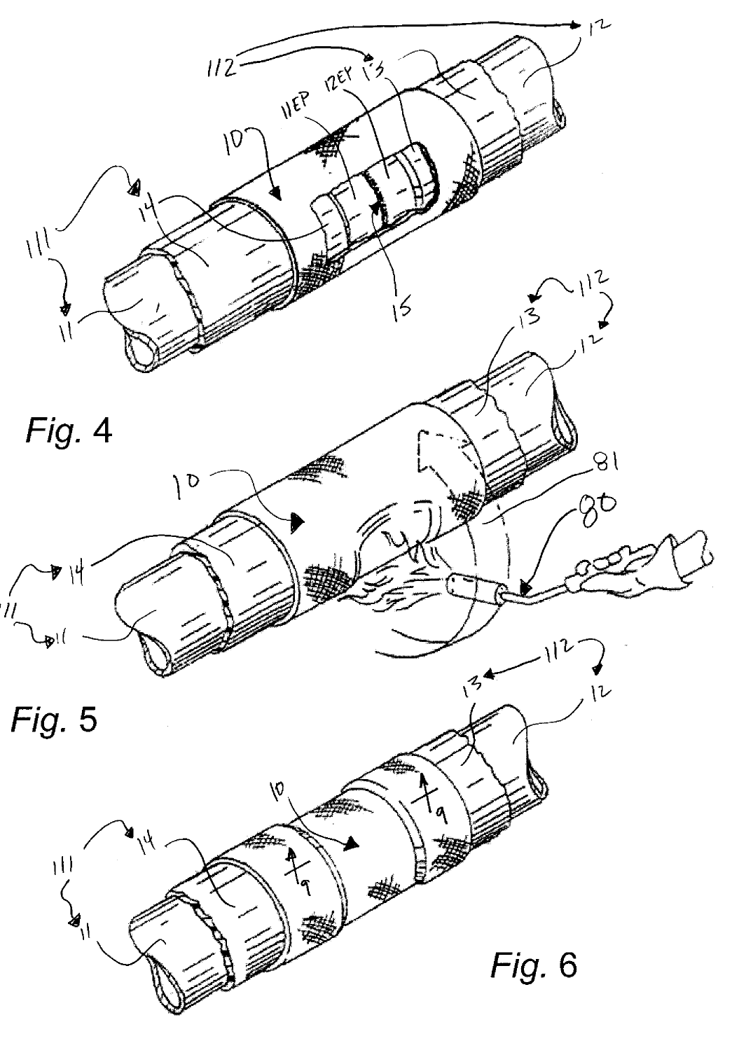

Sleeve 10 is used to cover the exposed portions 11EP, 12EP in a series of illustrative steps shown in FIGS. 1-6. First, sleeve 10 is slid onto first pipe unit 111 in first direction 101 while pipe units 111, 112 are spaced-apart from one another as suggested in FIG. 1. Second, pipe units 111, 112 are brought together, as shown in FIG. 2, so that a TIG welder 90 can be used to weld the pipe units 111, 112 as suggested in FIG. 3. Third, sleeve 10 remains in spaced-apart relation to joint 15 during welding to minimize damage or shrinkage of sleeve 10 from the welding heat as shown in FIG. 3. Fourth, once welding is complete, sleeve 10 is slid illustratively to the right in the second direction 102 to cover joint 15 as suggested in FIG. 4. Finally, heat is applied to sleeve 10 placed over joint 15 illustratively by a gas torch 80 as shown in FIG. 5 to produce the final protected joint as shown in FIG. 6.

As shown in FIG. 3, joint 15 is used to interconnect the ends of first metal pipe 11 and second metal pipe 12 by welding. Illustratively, first pipe unit 111 may be connected to second pipe unit 112 using a TIG welder 90, as shown in FIG. 3. It is within the scope of this disclosure to use any suitable welding technique. After joining first and second pipe units 111, 112, sleeve 10 can be arranged over the first pipe unit 111 and second pipe units 112 so as to cover the joint 15, the first exposed portion 11EP, and the second exposed portion 12EP, as suggested in FIG. 4.

As shown in FIG. 5, sleeve 10 is heated using gas torch 80 or other suitable heater to at least a predetermined temperature to cause a woven polyolefin layer 103 to shrink and conform to exposed portions 11 EP, 12EP of first and second pipe units 111, 112. Using an illustrative technique suggested in FIG. 5, gas torch 80 is moved around the circumference of sleeve 110 in direction 81 using a side-to-side motion to apply heat to all exposed exterior surfaces of sleeve 10.

After sleeve 10 has been heated to shrink and conform to exposed portions 11EP, 12EP of first and second pipes 11, 12, as suggested in FIGS. 6 and 7, a cathodic protection system 55 may function as shown in FIGS. 7 and 8. Cathodic protection system 55 illustratively includes a power source 50, an anode 51, and a connection 52 to metal pipe 12. The cathodic protection system 55 provides an electronic bias between metal pipe 11 and anode 51 to cause a net flow of electrons 53 to move from anode 51 through sleeve 10 and into metal pipe 11 as shown in FIG. 7.

As suggested in FIG. 8, electrons 53 are capable of moving through sleeve 10 because woven polyolefin layer 103 includes fibers 101 that define void spaces 102 between fibers 101. One characteristic of a polyolefin material is that it provides a high dielectric resistance. For example, a film of polyolefin may provide greater than 100 V/mil of resistance. As used herein, the term mil is equal to 1/1000^{th} of an inch. Coating 100 includes a polyolefin, but that polyolefin is woven, therefore, the polyolefin is not continuous across the coating, but rather it is non-continuous and has void spaces 102. Void spaces 102 have dielectric resistances different from the dielectric resistance of the polyolefin.

Void spaces 102 may become partially filled with adhesive upon heat shrinking and otherwise may become filled with surrounding materials; therefore, the dielectric resistance of void space 102 is linked to the dielectric resistance of the material which fills void spaces 102. For example, an in-ground pipe application may result in the void spaces 102 being filled with adhesive and with materials characteristic of the application, such as, air, dirt, water, sand, etc. Therefore, the dielectric resistance across the sleeve will be dependent on the dielectric resistance of the void-filling material. In many applications, void spaces 102 will be filled with materials having substantially lower dielectric resistance than polyolefin fibers 101. Accordingly, within an application, sleeve 10 overall will have a dramatically lower dielectric resistance than a comparable sleeve made with a continuous film.

In one aspect, the sleeve 10 exhibits intermittent or non-continuous dielectric resistance, but demonstrates the strength and corrosion protection characteristics of a comparable continuous film. The specifications sufficient to meet the requirements of a given application are strongly influenced by the actual application. For example, a sleeve that may be appropriate to cover the exposed portions of a given pipe may be matched to a particular exterior pipe coating. For example, where the exterior pipe coating includes a multi-layer product comprising of fusion bonded epoxy (FBE) and polyethylene; a sleeve with compatibility towards the FBE, the steel pipe, and the duty requirements of the pipe could be designed. This exemplary exterior pipe coating may be suitable for buried oil and gas pipe in environments where mechanical protection, moisture and corrosion resistance are of primary concern. Thus, a sleeve compatible with this duty would be used in this application. In another example, a pipe being used to transport water at moderate operating temperatures may only require a high density polyethylene extruded over a rubberized mastic adhesive. Accordingly, the sleeve used in this example would be compatible with the high density polyethylene, mastic, and steel. Furthermore, the sleeve's specifications may similarly be aligned to the less demanding duty of this exemplary application.

While the woven polyolefin layer exhibits intermittent or non-continuous dielectric resistance, its properties may be comparable to a cross-linked extruded solid non-woven film with respect to strength and durability. A continuous or monolithic polyolefin film has a high dielectric strength, for example, 100 V/mil or greater is not uncommon. A woven polyolefin backing exhibits non-continuous dielectric resistance due to its non-continuous structure. For example, the interstitial space between the woven polyolefin strands or threads allows for the conduction of current. In one embodiment, the woven polyolefin layer is made from master batches of suitable components including polyolefins, UV stabilizers, colorants, aging stabilizers, and cross-linking additives. During or after extrusion, the polyolefins are cross-linked through a cross-linking treatment. Typically, cross-linking is effectuated through either the inclusion of chemical cross-linking agents or by exposing the woven polyethylene to radiative cross-linking techniques, such as electron beam (e-beam) irradiation.

In illustrative embodiments, a sleeve includes a cross-linked polyolefin layer and an adhesive layer. The cross-linked polyolefin layer is cross-linked so that upon heating, the polyolefin layer shrinks. The cross-linking may be imparted on the polyolefin through irradiation or the incorporation of chemical cross-linking agents. The adhesive includes compatible mastic, hot-melt, epoxy, polyurethane, or other suitable adhesive materials.

In illustrative embodiments, the polyolefin layer is heat shrinkable. In one embodiment, the polyolefin layer shrinks by about 5% to about 200%, based on the reduction in length, upon heating. In another embodiment, the polyolefin layer shrinks by about 10% to about 60%, based on the reduction in length, upon heating. In yet another embodiment, the polyolefin layer shrinks by about 25% to about 50%, based on the reduction in length, upon heating. In one embodiment, the polyolefin layer shrinks from about 10% to about 60%, based on the reduction in length, upon heating. In one embodiment, heating includes raising the temperature of the polyolefin layer to at least about 60 degrees Celsius. In another embodiment, heating includes raising the temperature of the polyolefin layer into a range of about 60 degrees Celsius to about 200 degrees Celsius. In yet another embodiment, heating includes raising the temperature of the polyolefin layer into a range of about 100 degrees Celsius to about 160 degrees Celsius. In one embodiment, the shrink force is greater than about 30 psi, as determined by ASTM D-638 at 150 degrees C. In another embodiment, the shrink force is greater than about 40 psi, as determined by ASTM D-638 at 150 degrees C.

In illustrative embodiments, the polyolefin includes a weave exhibiting a non-continuous dielectric resistance. In one embodiment, the polyolefin exhibits a non-continuous dielectric resistance in the range from about 0 V/mil to about 1000 V/mil, as determined according to ASTM D-149. In another embodiment, the polyolefin exhibits a non-continuous dielectric resistance in the range from about 0 V/mil to about 500 V/mil, as determined according to ASTM D-149. In another embodiment, the polyolefin exhibits a non-continuous dielectric resistance in the range from about 0 V/mil to about 100 V/mil, as determined according to ASTM D-149. In another embodiment, the elongation is greater than or equal to about 300%, as determined by ASTM D-638. In another embodiment, the elongation is greater than or equal to about 500%, as determined by ASTM D-638. In one embodiment, the tensile strength is greater than about 2000 psi, as determined by ASTM D-638. In another embodiment, the tensile strength is greater than about 3000 psi, as determined by ASTM D-638.

The thickness of the woven polyolefin layer and one or more adhesive layers depend on particular application requirements. In one embodiment, the thickness of the woven polyolefin layer is from about 3 to about 50 mils. In another embodiment, the thickness of the woven polyolefin layer is from about 10 to about 30 mils. In yet another embodiment, the thickness of the coating is from about 10 to about 100 mils. In another embodiment, the thickness of the coating is from about 15 to about 80 mils.

In illustrative embodiments, fibers include a cross-linked polyolefin that shrinks upon heating. As used herein, the term polyolefin is used generally to describe a polymer produced from a simple olefin, such as an alkene, with the general formula CₙH₂ₙ, as a monomer. Polyolefin includes polyethylene and polypropylene and blends thereof. As used herein, the polypropylene (PP) includes polymers with various molecular weights, densities, and tacticities synthesized from propylene monomers.

Polyethylene (PE) includes polymers made through a polymerization of ethylene. For example, PE may include those polymers of ethylene polymerized through a free radical polymerization. For example, PE may have a high degree of short and long chain branching. PE also includes copolymers of ethylene and an alpha olefin comonomer made through a single site catalyzed reaction (e.g., through a metallocene catalyzed reaction) or a blend thereof with an elastomer or high pressure low density polyethylene. PE includes copolymers made with various alpha olefin monomers including 1-butene, 3-methyl-1-butene, 3-methyl-1-pentene, 1-hexene, 4-methyl-1-pentene, 3-methyl-1-hexene, 1-octene or 1-decene. For example, the alpha olefin comonomer may be incorporated from about 1% to about 20% by weight of the total weight of the polymer, preferably from about 1% to about 10° A by weight of the total weight of the polymer. While specific polymer compositions are referred to herein, one of ordinary skill in the art will appreciate that polymers or polymer blends with substantially equivalent physical properties could be substituted, yet remain within the scope and spirit of the present disclosure. In particular, those polymers having substantially equivalent melt indexes (MI) and flow ratios (FR) may be particularly suitable. One of ordinary skill in the art will appreciate that MI (units herein of g/10 min) is an indication of molecular weight, wherein higher MI values typically correspond to low molecular weights. At the same time, MI is a measure of a melted polymer's ability to flow under pressure. FR is used as an indication of the mariner in which rheological behavior is influenced by the molecular weight distribution of the material.

The polyolefin layer is comprised of polyolefin fibers woven into a weave such that the layer exhibits a non-continuous dielectric resistance. As used herein, a fiber is the basic element of a fabric having a length at least 100 times its diameter or width which can be made into a fabric. The term fiber is not limited to a particular geometric cross-section, but instead includes all fiber cross-sections currently known in the art or discovered thereafter. For example, the term fiber includes those fibers having a circular or rectangular cross section. The term fiber includes monofilament fibers or yarns which includes fibers made of two or many filaments. In one embodiment, the weave is selected from a group consisting of plain weave, satin weave, twill weave, basket weave, jacquard weave, rib weave, dobby weave, leno weave, and oxford weave. In another embodiment, the denier of the polyolefin fiber is in the range from about 200 to about 4000 denier. As used herein, the term denier is a unit of measure for the linear mass density of fibers. It is defined as the mass in grams per 9,000 meters of the fiber.

The adhesive may be referred to as an anti-corrosion adhesive because it prevents the penetration of liquids (for example, alkaline or acidic water), gases (for example, air and water vapor), microbes and fungi to the surface of the substrate (for example, pipe). The adhesive is contacted to the woven cross-linked polyolefin layer and forms a layer adjacent to the woven cross-linked polyolefin layer. The coating may be applied to a substrate by arranging the coating so that the adhesive contacts the substrate. The woven cross-linked polyolefin layer is conformable to the shape of the substrate and the adhesive layer provides adhesion between the substrate and the woven polyolefin layer.

As used herein, the term adhesive includes those materials known in the art as adhesives. For example, one of ordinary skill in the art would appreciate that mastic, hot-melt, polyurethane, polyimide, synthetic rubber, and epoxy adhesives may be used. One aspect of the present disclosure is that the adhesive layer assures long-term bonding of the polyolefin layer to the pipe or substrate, and provides principal corrosion resistance and added mechanical strength to the coating.

In one embodiment, at least one adhesive has a softening point of greater than 50 degrees C., as determined by ASTM E-28. In another embodiment, at least one adhesive has a softening point of greater than 80 degrees C., as determined by ASTM E-28. In yet another embodiment, at least one adhesive has a softening point of greater than 100 degrees C., as determined by ASTM E-28. In one embodiment, at least one adhesive has a peel to steel of greater than 10 lbs/in. width, as determined by ASTM D-1000. In another embodiment, at least one adhesive has a peel to steel of greater than 15 lbs/in. width, as determined by ASTM D-1000. In yet another embodiment, at least one adhesive has a peel to steel of greater than 20 lbs/in. width, as determined by ASTM D-1000. In one embodiment, at least one adhesive has an impact resistance of greater than 20 in-lbs, as determined by ASTM G-14. In another embodiment, at least one adhesive has an impact resistance of greater than 30 in-lbs, as determined by ASTM G-14. In yet another embodiment, at least one adhesive has an impact resistance of greater than 40 in-lbs, as determined by ASTM G-14. In one embodiment, at least one adhesive has a penetration resistance of less than about 20%, as determined by ASTM G-17. In another embodiment, at least one adhesive has a penetration resistance of less than about 15%, as determined by ASTM G-17. In yet another embodiment, at least one adhesive has a penetration resistance of less than about 10%, as determined by ASTM G-17.

Surprisingly, it was found that embodiments of the present disclosure were also more conformable than continuous films with similar specifications. Accordingly, embodiments of the present disclosure may be useful in a broader range of potential applications. The use of a woven polyolefin provides improved compatibility between the adhesive layer and polyolefin layer. While not being limited to theory, the compatibility of the adhesive layer and a woven polyolefin layer is improved because the adhesive may inter-digitate the woven layer partially filling the voids. This inter-digitation increases the surface contact area between the adhesive and the polyolefin and may result in additional physical inter-locking which could not occur with a continuous film.

As shown in FIGS. 10-13, various embodiments of a coating used to form a sleeve are variation of coating 100. As shown in FIG. 10, coating 100 includes a woven polyolefin layer 103 coupled to an adhesive layer 104. Another embodiment of coating 200, as shown in FIG. 11, includes a first adhesive layer 204, a polyolefin layer 103, and second adhesive layer 104. Polyolefin layer 103 of coating 200 interconnects first and second adhesive layers 104, 204. Yet another embodiment of coating 300, as shown in FIG. 12, includes woven polyolefin layer 103, adhesive layer 104 coupled to polyolefin layer 103, and a release layer 305 coupled removably to adhesive layer 104. Release layer 305 is used to aid in the installation of the sleeve to prevent adhesive layer 104 from sticking to itself prior to installation. Another embodiment of a coating 400, as shown in FIG. 13, includes a first release layer 405, first adhesive layer 204, woven polyolefin layer 103, second adhesive layer 104, and second release layer 305.

1. A pipe coating comprising
a polyolefin layer and
a first adhesive layer, wherein the polyolefin layer is heat-shrinkable and woven.

2. The pipe coating of claim 1, wherein the polyolefin layer is cross-linked.

3. The pipe coating of claim 2, wherein the polyolefin layer is e-beam irradiation cross-linked.

4. The pipe coating of claim 2, wherein the polyolefin layer is non-radiatively cross-linked.

5. The pipe coating of claim 1, wherein the polyolefin layer shrinks by about 10% to about 60% upon heating.

6. The pipe coating of claim 1, wherein the polyolefin layer shrinks by about 25% to about 50% upon heating.

7. The pipe coating of claim 1, wherein the polyolefin layer includes a weave exhibiting a non-continuous dielectric resistance.

8. The pipe coating of claim 1, wherein the first adhesive layer comprises an adhesive selected from a group consisting of mastics, hot-melts, polyurethanes, polyimides, synthetic rubbers, and epoxies.

9. The pipe coating of claim 1, further comprising a release liner, wherein the first adhesive layer is in contact with and interposed between the polyolefin layer and the release liner.

10. The pipe coating of claim 9, wherein the second adhesive layer comprises an adhesive selected from a group consisting of mastics, hot-melts, polyurethanes, polyimides, synthetic rubbers, and epoxies.

11. The pipe coating of claim 1, further comprising a second adhesive layer, wherein the polyolefin layer is in contact with and interposed between the first adhesive layer and the second adhesive layer.

12. The pipe coating of claim 11, further comprising a first release liner and a second release liner, wherein the first adhesive layer is interposed between the first release liner and the polyolefin layer and the second adhesive layer is interposed between the second release liner and the polyolefin layer.

13. The pipe coating of claim 1, wherein the polyolefin layer comprises a polyolefin selected from a group consisting of polyethylene, polypropylene and blends thereof.

14. An apparatus for covering a pipe, the apparatus comprising
at least one adhesive layer in contact with a woven heat-shrinkable polyolefin backing, wherein the at least one adhesive layers and the woven heat-shrinkable polyolefin backing are arranged as to form a composite with a non-continuous dielectric resistance.

15. The apparatus of claim 14, wherein the woven heat-shrinkable polyolefin backing is cross-linked.

16. The apparatus of claim 15, wherein the woven heat-shrinkable polyolefin backing is irradiatively cross-linked.

17. The apparatus of claim 14, wherein the woven heat-shrinkable polyolefin backing shrinks from about 10% to about 60%, based on circumferential length in response to the woven heat-shrinkable polyolefin backing being heated to at least about 60 degrees Celsius.

18. The apparatus of claim 14, wherein the at least one adhesive layer is adapted to cover the pipe upon shrinking of the woven heat-shrinkable polyolefin backing which substantially seals the pipe from water and water vapors without sealing the pipe from passage of current.

19. The apparatus of claim 14, wherein the at least one adhesive layer comprises an adhesive selected from a group consisting of mastics, hot-melts, polyurethanes, polyimides, synthetic rubbers and epoxies.

20. The apparatus of claim 14, wherein the woven polyolefin heat-shrinkable backing comprises a polyolefin selected from a group consisting of polyethylene, polypropylene and blends thereof.

21. A method of producing a heat shrinkable coating comprising the steps of
subjecting a woven polyolefin layer to a radiative cross-linking process,
expanding the woven polyolefin layer using a stretching device to produce an expanded woven polyolefin layer, and
contacting an adhesive layer to the expanded woven polyolefin layer.

22. The method of producing a heat shrinkable coating of claim 21 further comprising the step of contacting the adhesive layer with a release liner.

23. The method of producing a heat shrinkable coating of claim 22 further comprising the step of rolling the heat shrinkable coating.

24. The method of producing a heat shrinkable coating of claim 21 further comprising the step of preheating the woven polyolefin layer.

25. The method of producing a heat shrinkable coating of claim 24 further comprising the step of annealing the expanded woven polyolefin layer.

26. The method of producing a heat shrinkable coating of claim 21 further comprising the step of forming the heat shrinkable coating into a sleeve.
